(19) United States
(12) Patent Application Publication
(10) Pub. No.: US 2016/0107482 A1
(43) Pub. Date: Apr. 21, 2016

(54) WHEELSET SHAFT FOR RAIL VEHICLES

(71) Applicant: SIEMENS AG ÖSTERRREICH, Wien (AT)

(72) Inventors: Peter KOSCHUTNIG, Eisbach (AT); Jürgen LEHNER, Graz (AT); Marcus Anton WIMMER, Graz (AT)

(21) Appl. No.: 14/892,894

(22) PCT Filed: May 8, 2014
(86) PCT No.: PCT/EP2014/059435

§ 371 Date: Nov. 20, 2015

(30) Foreign Application Priority Data
Jun. 5, 2013 (AT) A50372/2013

(51) Int. Cl. B60B 37/00; G06K 7/10

(52) U.S. Cl. CPC B60B 37/00; G06K 7/10366; B60B 2900/00

(57) ABSTRACT

A wheelset shaft for rail vehicles, wherein in order to be able to read a wheelset identification number with the wheelset shaft in any position, and to do so quickly, correctly and automatically, at least one RFID Tag is attached to the wheelset shaft.

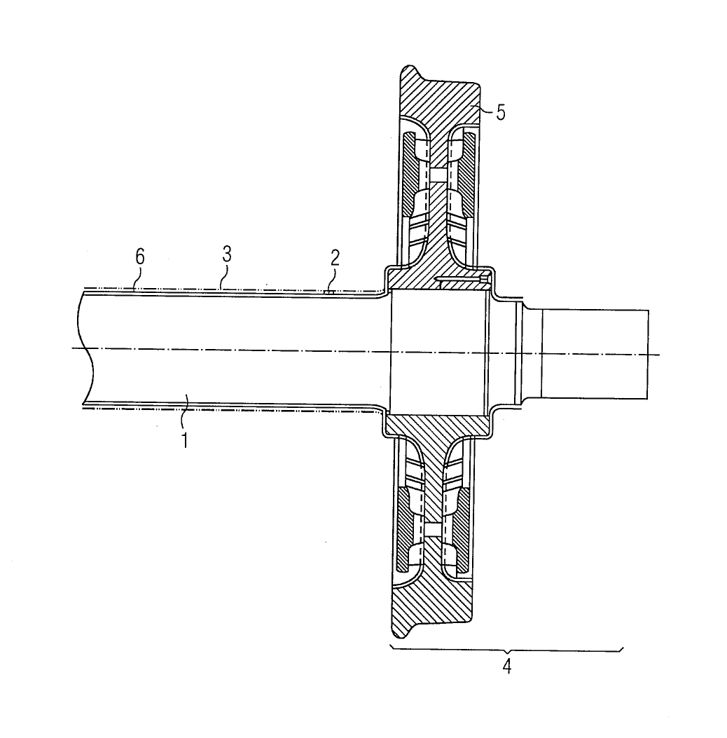

### CROSS-REFERENCE TO RELATED APPLICATIONS

This is a U.S. national stage of application No. PCT/EP2014/059435 filed 8 May 2014. Priority is claimed on Austrian Application No. A50372/2013 5 Jun. 2013, the content of which is incorporated herein by reference in its entirety.

### BACKGROUND OF THE INVENTION

1. Field of the Invention

The invention relates to a wheelset shaft for rail vehicles and to an identification system of wheelset shafts in rail vehicles.

2. Description of the Related Art

Wheelset shafts must be regularly identified not only during production but also during operation and maintenance of rail vehicles. This is a requirement to be able to ensure the safe operation of rail vehicles.

In order to identify wheelset shafts, it is known to indent a serial number herein, which can subsequently be read off for identification purposes. The disadvantage here is that the readout process is slow and prone to error because errors occur during the transfer of the number and moreover the readout process cannot be automated. A further significant disadvantage is the situation in which, when the wheelset shaft is integrated, the position of the number can also not be disposed at a non visible point depending on the position of the wheelset shaft. The wheelset identification number can be disposed for instance on the front side of the wheelset shaft, which is not visible in the integrated state.

### SUMMARY OF THE INVENTION

It is therefore an object of the present invention to provide a wheelset shaft for rail vehicles, in which the readout process can furthermore also be performed rapidly, correctly and automatically in each position of the wheelset shaft.

This and other objects and advantages are achieved in accordance with the invention by a wheelset shaft for rail vehicles having at least one radio-frequency identification (RFID) tag that is fastened to the wheelset shaft. Consequently, data can be transferred contactlessly with the aid of electromagnetic fields via the RFID tag, which is also referred to as RFID transponder. Moreover, data can also be stored in the RFID tag, such as a serial number and data relating to production or also other data. By fastening one or a number of RFID tags to the wheelset shaft, it is possible to automatically read out the data stored in the RFID tag, such as by a reading device fastened in the track bed. The readout process via a reading device also avoids errors caused by human operators when writing off the serial number. The position of the inventive wheelset shaft and thus that of the RFID tag with respect to the shaft is also insignificant to the readout process. An unfavorable position of the wheelset shaft has prevented the simple identification of the serial number in the known, conventional write-off methods, as mentioned above.

The identification, or the reading-out of the stored data occurs in the inventive wheelset shaft much faster than in the case of a manual writing-off of the serial number.

If the RFID tag is fastened to the wheelset shaft via an adhesive, a simple and secure connection can be realized. This is possible without major effort.

In one embodiment of the inventive wheelset shaft, in which the wheelset shaft has an impact protection coating, it is possible to fasten the RFID tag to the impact protection coating. An RFID tag can thus also subsequently be fastened to a finished wheelset shaft using the impact protection coating.

Provision can be made in particular for the RFID tag to be arranged at least partially within the impact protection coating. By integrating the RFID tag into the impact protection coating, the RFID tag is protected against damage from the outside. Provision can be made here for the impact protection coating to completely cover the RFID tag in the fastened state. Provision can also be made for the impact protection coating to be flush with the side of the RFID tag facing away from the wheelset shaft or for the RFID tag to protrude from the impact protection coating. Moreover, provision can be made for a layer of impact protection coating to be disposed between the RFID tag and the wheelset shaft.

Provision can basically be made for a number of RFID tags to be fastened to the wheelset shaft. As a result, various functions can be triggered, for instance, with different RFID tags. It is conceivable, for instance, to store the serial number on an RFID tag, while more sensitive data is stored in encrypted form on the same or another RFID tag.

Provision can be made for at least one RFID tag to be formed as a passive RFID tag. Here, the advantage lies in a passive RFID tag that does not require a power supply. Provision can also be made for at least one RFID tag to be formed as an active RFID tag.

The identification system of wheelset shafts in rail vehicles comprises at least one inventive wheelset shaft with an RFID tag and an RFID reading device. One possible device for identifying inventive wheelset shafts contains at least one RFID reading device and is fixedly mounted in the region of the track.

### BRIEF DESCRIPTION OF THE DRAWINGS

To further explain the invention, reference is made in the later part of the description to the FIGURE from which further advantageous embodiments, details and developments of the invention are inferred. The drawing is to represent the inventive idea but, however, is in no way to restrict or even reproduce it.

The FIGURE shows the view of a cutout of a wheelset shaft in accordance with the invention.

### DETAILED DESCRIPTION OF THE EXEMPLARY EMBODIMENTS

The FIGURE shows a cutout of an inventive wheelset shaft 1 having an RFID tag 2 and an impact protection coating 3.

The imaged cutout of the wheelset shaft comprises an end region 4 of the wheelset shaft, to which a wheel 5 is attached. The wheelset shaft 1 continues to the left, and a wheel is likewise attached to its other end region (not shown).

Paintwork 6 is applied to the wheelset shaft 1. The RFID tag 2 is attached to the paintwork 6 and the impact protection coating 3 is applied above the paintwork 6 and the RFID tag 2. There is no impact protection coating 3 in this embodiment of the inventive wheelset shaft 1 between the RFID tag and the wheelset shaft, but instead on all other sides of the RFID tag 2.

Provision can be made for the RFID tag 2 to be attached directly to the wheelset shaft 1, which is not the case in the embodiment shown in the FIGURE.

Provision can essentially be made for the RFID tag to be read out via a mobile RFID reading device and/or an RFID gate, in other words a portal, which surrounds a track system.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A wheelset shaft for rail vehicles, wherein at least one RFID tag is fixedly fastened to the wheelset shaft.

11. The wheelset shaft as claimed in claim 10, wherein the RFID tag is fastened via an adhesive to the wheelset shaft.

12. The wheelset shaft as claimed in claim 10, wherein the wheelset shaft has an impact protection coating; and wherein the RFID tag is fastened to the impact protection coating.

13. The wheelset shaft as claimed in claim 12, wherein the wheelset shaft has an impact protection coating; and wherein the RFID tag is fastened to the impact protection coating.

14. The wheelset shaft as claimed in claim 13, wherein the RFID tag is arranged at least partially within the impact protection coating.

15. The wheelset shaft as claimed in claim 14, wherein the impact protection coating completely covers the RFID tag in the fastened state.

16. The wheelset shaft as claimed in claim 10, wherein a plurality of RFID tags are fastened to the wheelset shaft.

17. The wheelset shaft as claimed in claim 16, wherein at least one RFID tag comprises a passive RFID tag.

18. The wheelset shaft as claimed in claim 16, wherein at least one RFID tag comprises an active RFID tag.

19. A device for identifying wheelset shafts as claimed in claim 10, wherein the device contains at least one RFID reading device and is fixedly mounted in a region of the a track.
